(19) United States
(12) Patent Application Publication
(10) Pub. No.: US 2013/0232072 A1
(43) Pub. Date: Sep. 5, 2013

(54) Method of Using a Cell Phone to Authenticate a Commercial Transaction

(71) Applicant: Robert D. Fish, Tustin, CA (US)

(72) Inventor: Robert D. Fish, Tustin, CA (US)

(21) Appl. No.: 13/777,590

(22) Filed: Feb. 26, 2013

Related U.S. Application Data
(60) Provisional application No. 61/605,363, filed on Mar. 1, 2012.

(51) Int. Cl. G06Q 20/32

(52) U.S. Cl. CPC G06Q 20/3227
USPC 705/44

(57) ABSTRACT

A cell-phone or other user-side electronic device provides a user-side time-dependent key that is accessed through use of an entry key and/or a different seed. A bank or other funding institution, or an intermediary, uses the user-side time-dependent key to either approve or deny a commercial transaction. Entry keys and seeds can independently be typed passcodes, but could alternatively or additionally comprise one or more of audio signals, a tactile signal, a biometric, and/or a visual. Entry keys and/or seeds could vary by at least one of identity of user, day, date, time of day, and amount of transaction.

This application claims priority to U.S. provisional application, Ser. No. 61/605363, filed Mar. 1, 2012, which is incorporated herein by reference in its entirety.

### FIELD OF THE INVENTION

The field of the invention is authentication of commercial transactions, especially transactions using credit cards and debit cards.

### BACKGROUND

Credit and debit card fraud continues to be a huge problem for financial institutions. Requiring a physical card provides only limited protection because validly issued cards can be stolen, and because it is a relatively easy process to manufacture duplicate cards. Moreover, many purchases and other transactions are performed distally to the card holder's then-current physical location, so that at some point in time the card number and the security code need to be transmitted, orally or electronically, to the entity putting through the transaction. During transmission or later storage of such codes, the numbers can be stolen.

Use of the printed security code on the back of the card adds only marginal protection because that number also needs to be transmitted, orally or electronically, to any distal entity putting through the transaction.

PayPal™ and similar services provide some measure of protection for consumers because they maintain credit card and security code numbers for the consumers, thereby obviating the need to retransmit such information each time a purchase is made. However, fraud can still occur when the PayPal or other account number and password are stolen.

As evidence that a continued problem exists, PayPal now sells a security key that creates time-dependent security codes that can be used by a consumer when he/she logs in to the PayPal account. However, that solution is still problematic because the security key can be readily stolen. But the problem remains that whoever steals a wallet or purse containing the security key, and who knows the account number and password, can fraudulently use the service.

Google Wallet™ is a phone-based system using near-field communication. In that system a user simply bumps his/her phone against a receiver to authorize a transaction. One problem is that access to Google Wallet is made through a simple password, and if that password is stolen, one will have access to at least portions of a users credit card numbers, expiration date, security code, balance information, and perhaps even access codes to the user's automobile, house and so forth. Of course, not all consumers want to carry that information on their cell phone, which could be stolen and hacked. Worse still as of December 2011 it was reported that Google Wallet stores all that information on the cell phone in various SQLite databases in unencrypted form, and creates a recoverable image of credit cards. In addition, near-field communication won't work for distal transactions, such as those over the Internet.

US20050154643 to Doan teaches a user receiving a temporary number that the credit card company or other processing entity then maps to a valid credit card number. That system, however, is ineffective to protect against credit card fraud where the vendor is processing a physical card. Doan's system is also terribly inconvenient because users need to contact their bank or other organization every time they want to make a purchase.

US20070178883 to Nandagopal teaches the use of a cell phone for authentication, but there is no generation of a time-dependent key. A similar problem exists with respect to US20100325716 to Hong, which teaches using a cell phone to authenticate access to a document processing device.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for a simple, robust security system for handling credit, debit and other transactions.

### SUMMARY OF THE INVENTION

Methods, systems and apparatus are contemplated herein in which a user-carried device is used to produce a user-side time-dependent key further to receiving a distinguishing input from the user, and that key is compared against a funding-side time-dependent key to assist in authorizing a transaction.

The user-carried device is preferably a cell phone, which runs an app that generates the user-side time-dependent key. That key is then forwarded, spoken or otherwise sent to whatever entity is conducting the transaction, which in turn either compares it to a funding-side time-dependent key, or forwards it along to a bank, clearinghouse or other institution for comparison to a funding-side time-dependent key. As used herein, the term “cell phone” means any device that communicates using a cellular protocol, and expressly includes hardware and software disposed within the same general housing. Thus, all of the components of an Apple™ iPhone™ are considered part of a cell phone, including both the telephony portion of the device, as well as the display screen, all processors, all memories, speaker(s), microphone(s), and so forth, even if they are not involved in telephony function. On the other hand, a tablet such as the original Apple™ iPad 2™, as originally shipped from the factory, is not considered a cell phone as the term is used herein because it does not use cellular protocol, even though a user could utilize the device to make a call through a service such as Skype™.

An important aspect of one aspect of the inventive subject matter is that the user provides a passcode or other distinguishing input, which preferably consists of an entry key and/or a seed, to the user-carried device to secure the user-side time-dependent key. This differentiates the currently contemplated methods, systems and apparatus from physical security key devices, such as those provided by funding entities including Wells Fargo™ and other banks, and PayPal™.

Use of an entry key also differentiates the currently contemplated methods, systems and apparatus from near-field transaction systems. In Google Wallet™, for example, everyone has the same input, namely a bump of the cell phone against a receiver. Aside from the fact that there appears to be no user-side time-dependent key of any sort, even if there were such a key, that key would not be created further to receiving a distinguishing input from the user.

In some embodiments it is contemplated that the distinguishing input could be a password or other confidential information used to operate the cell phone or other device, rather than the entry key (which is used to open the key-generating app), or the seed.

The funding-side time-dependent key is preferably created by or on behalf of funding entity, which could fore example, be a bank, or other financial institution, or an intermediary such as a clearing house or a company such as PayPal™. Coordination of the user-side production of keys with the funding-side production of keys could be facilitated using an electronic portal set up by or on behalf of the funding entity.

Various objects, features, aspects and advantages of the inventive subject matter will become more apparent from the following detailed description of preferred embodiments, along with the accompanying drawing figures in which like numerals represent like components. The figures are not drawn to scale.

### BRIEF DESCRIPTION OF THE DRAWING

FIG. 1 is a schematic of a user utilizing a portable device to obtain a user-side time-dependent key.

FIG. 2 is a schematic of the user of FIG. 1 providing the user-side time-dependent key to a recipient.

FIG. 3 is a schematic of website used to coordinate production of user-side time-dependent keys funding-side time-dependent keys.

FIG. 4 is a listing of steps in a class of preferred methods.

### DETAILED DESCRIPTION

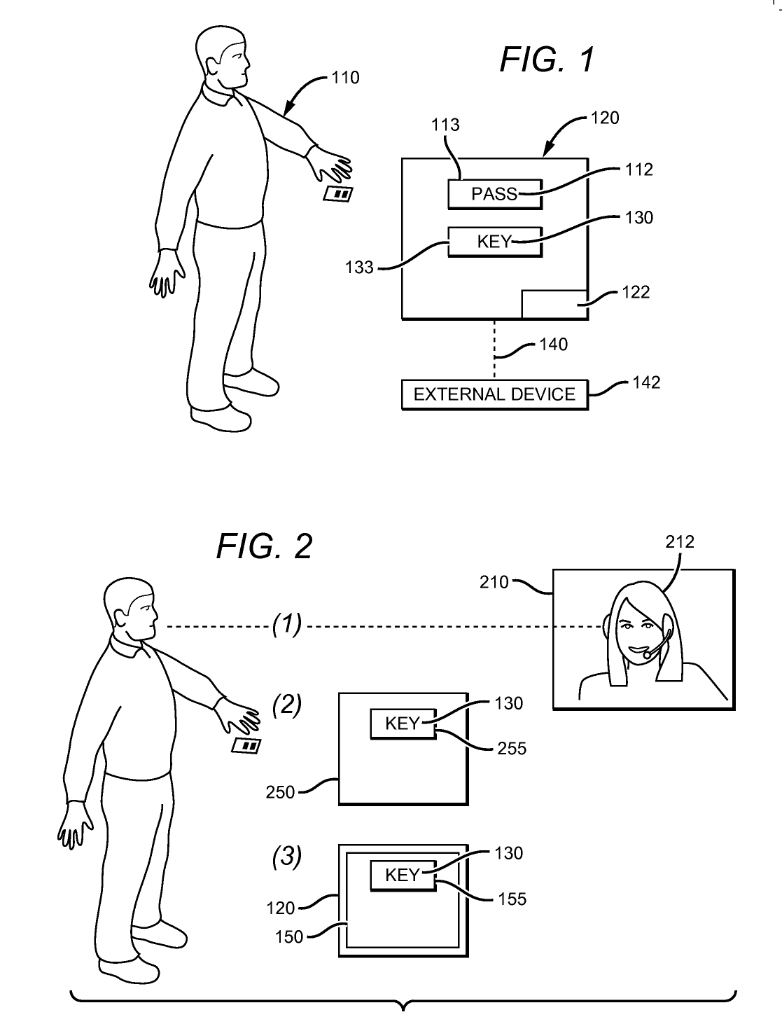

In FIG. 1, a user 110 provides distinguishing input 112 to a field 113 of a user-carried device 120, and the device 120 returns a user-side time-dependent key 130 in field 133. The key 130 is preferably generated internally to the user-carried device 120 using hardware and/or hardware-stored software (collectively 122) that runs an algorithm. The dotted lines 140 depict wired or wireless communication of the user-carried device 120 to an optional external device 142, which generates or assists in generating the user-side time-dependent key 130

The user-carried device 120 can be a cell phone, PDA, tablet, laptop or other portable computer, smart-card, and so forth. Production of the user-side time-dependent key could be created using native software and/or hardware, but is preferably created using an “app” that could be downloaded from the Apple™ App Store™ the Android™ Marketplace™, and so forth. The user-side time-dependent key could also be generated distally, as for example, by a server or through cloud-based computing, and then reported back to the user-carried device, further to processing of the distinguishing input.

It is contemplated that the distinguishing input 112 can include either or both of an entry key and a seed. As used herein the term “entry key” is a password or other identifying information that allows a user access to an app or other program. The entry key is likely (but not necessarily) stored in the device so that the device can compare that entered with that previously stored. A used herein the term “seed” is a password or other identifying information used by a suitable algorithm to produce the user-side time-dependent key 130. As a quick example, the user might enter “20120915” as the entry key to open an app on his/her cell phone, and then enter “1113” as the seed. The app would then use 1113 as a variable in an algorithm to produce the user-side time-dependent key 130.

Some contemplated systems and methods can operate with no seed per se. In such cases, the user merely enters the entry key, and the app responds by displaying or otherwise providing a time-dependent code. The user could then type that code into a computer or terminal, or relay that code to a sales clerk, preferably augmented by a password. Thus, if the generated time-dependent code were 123123, the user might enter 999123123.

As of the filing date of this applicant there is no particular preference for any specific algorithm. In addition to relying on date/time, and perhaps a MAC address or other unique identifier to the user-carried device as input variables, contemplated algorithms could use the entry key as a variable, use both an entry key and a different seed as variables, or use only the seed as a variable.

Entry keys and seeds can independently be typed passcodes, but could alternatively or additionally comprise one or more of audio signal (as for example a whistled tune or spoken words, numbers or letters), a tactile signal (as for example a sequence of taps or squiggle movement of a finger on a display screen), a biometric (as for example a fingerprint or facial image acquired by the device proper or through an attachment, or an odor), and/or a visual (such as an image of a pencil or wallet). Passcodes are preferably created and modified by the users, and could be as simple as a short alphanumeric code, as for example 11A7 or 1278!#.

It is further contemplated that the entry key and/or the seed could vary over time. For example, the entry key or seed could be BOB1123 on Mondays, BOB2123 on Tuesdays, BOB3123 on Wednesdays, etc, or even BOB788 on Mondays, Mary788 on Tuesdays, June720 on Wednesdays, and so forth. Or the entry key and/or the seed could be BOB123M in the morning and BOB123A in afternoon. The seed could alternatively or additionally include information related to the purchase amount, which would prevent an unscrupulous vendor from using credit/debit card and time-dependent key information to run through a charge for an amount different from what the credit/debit card holder was expecting. For example, a user might enter a seed of BOB235 to authorize a charge of $235.67, and BOB19 to authorize a charge of $19.26. As another example, a user might enter a seed of BOB0 for purchases under $100, BOB1 for purchases of $100-$199.99, and BOB2 for purchases of $200-$299.99. It is contemplated that the funding-side server or service would provide a mechanism by which users could choose or otherwise designate how their inputted seed would vary over time.

Still further, the seed could vary by identity of user. Thus, a single credit card could be used by a father and his son, but each would have a different seed. The bank or other funding entity could use the resulting user-side time-dependent transaction to distinguish which person was engaging in the transaction.

The use of a seed, with or without an entry key, is thought to be of great benefit in reducing credit/debit card fraud. Even if a thief steals both a credit/debit card and the key-producing cell phone or other device, and even if the thief is able to hack into the key-producing app, he/she cannot use the credit/debit card because he/she won't know the user-inputted seed. The thief could produce time-dependent keys all day long, but they won't be valid. Other measures could also be taken on the side of the funding entity, such as invalidating the credit/debit card number after 3 or 4, or other small number of attempts to used invalid user-side time-dependent keys within a 15 minute or other given period of time.

Still further, many credit/debit cards are used fraudulently days after they are stolen, or for different amounts than the original purchase. With seeds that vary over time and by amount, a thief likely still couldn't use the credit/debit card even if the thief saw the user enter the seed, and then stole both the credit/debit card information and the key-producing device. Thus, if a user entered seed that included both day of the week and amount according to the formula BOB<day of week><price range>3, then he would enter BOB103 for Monday purchases under $100, BOB113 for Monday purchases of $100-$199.99, and BOB223 for Tuesday purchases of $200-$299.99. With that type of seed it is likely that the account would be closed down before the thief would use a correct key to complete the transaction.

Banks or other funding entities might even provide some sort of premium or other benefit for users that utilize sophisticated seeds. They might also require time-dependent keys to be used in conjunction with high ticket purchases or high credit line or high balance accounts.

As an alternative to an app on a cell phone or tablet, a credit card sized device could have hard or soft keys for entering a password as the entry key, which would then trigger display of a user-side time-dependent key. The user-side time-dependent key might remain visible for 30 seconds, or some other desired time limit, and then either roll over to display a different time-dependent key, or require re-entry of the password before displaying another time-dependent key.

It is contemplated that the user 110 could have also set up an alternate entry key and/or seed that is reserved for situations of duress. For example, if the user is being threatened under gun point to conduct a transaction, the user could enter the alternate entry key and/or seed, which would return a valid user-side time-dependent key 130 that would appear to allow the transaction to go through, but would also serve to alert a financial institution, intermediate or other entity that the transaction is being forced.

It is still further contemplated that a time-dependent key could be produced by an app running on a cell phone without either requiring the user to provide an entry key or a seed. In such cases the code provided to the vendor or intermediary would preferably be a concatenation of a confidential code and the current time-dependent key. For example, if the cell phone app provides a time-dependent key of 1387, the user might submit 99991387 as the then-current key, where the prefix 9999 is the confidential code. This has some similarity to use of an electronic bank key in conjunction with Wells Fargo's web-based Commercial Electronic Office. In that system a user also enters a concatenation of a confidential code and the current time-dependent key, but the time-dependent key is not generated by a cell phone.

The user-side time-dependent key 130 produced by the device 120 is preferably relatively short, perhaps only 7 or 8 characters, so that the key could be displayed or otherwise conveniently reported to the user, who could then type the key into a field on a laptop, table, desktop computer, and so forth. A relatively short key is also advantageous in that it could conveniently be provided orally (i.e., read) to a human or computer over a phone, Skype™ or other connection. It is still further contemplated that the user-side time-dependent key 130 could be used to auto-populate an appropriate display or other field rendered by the user-carried device 120, thus obviating the need for the user 110 to type or say the key. The characters could be numerals, letters or other characters, or any combination of those.

The user-side time-dependent key 130 is preferably current (i.e., valid) for only a short period of time, as for example no more than 5 minutes, no more than 2 minutes, no more than 1 minute, no more than 45 seconds, or no more than 30 seconds. The window of currency is preferably selected as a length of time sufficient to complete a large percentage of electronic transactions such as those involved in purchasing goods over the Internet. The user-side time-dependent key could also be called a current time-dependent key, a then-current time-dependent key, or a first time-dependent key. The funding-side time-dependent key could also be called a second time-dependent key.

It is contemplated that the user-side time-dependent key 130 could be used in addition to, or instead of, a static security code. For example, modern credit cards typically depict a credit card number on the front of the card, along with the name of the account holder, and an expiration date. They also include a static security code on the back of the card. When conducting a transaction, a vendor typically requires each of those four items, card number, name, date and security code. It is now contemplated that the user could provide the user-side time-dependent key 130 as the security code, which of course would no longer be static, but would change for each transaction.

In FIG. 2 the user 110 provides the user-side time-dependent key 130 to a recipient 210 that is conducting the transaction. The recipient 210 should be interpreted as a vendor, or a service (e.g., PayPal™ or Amazon™) used by a vendor to secure funding for the transaction. Sending of the key could be accomplished in any appropriate manner. The communication depicted should be interpreted to include as possibilities (1) speaking to clerk 212 by telephone or in person as shown by line 215, (2) the user 110 entering the user-side time-dependent key 130 into a field 255 a web page 250; and (3) the user-carried device 120 automatically submitting the user-side time-dependent key 130 into a field 155 of a web page 150 as it is rendered on that device 120.

As discussed above, the funding-side time-dependent key is preferably created by or on behalf of funding entity, which could, for example, be a bank, or other financial institution, or an intermediary such as a clearing house or a company such as PayPal™. Coordination of the user-side production of keys with the funding-side production of keys could be facilitated using an electronic portal set up by or on behalf of the funding entity.

To authorize the transaction the user-side time-dependent key should be identical to, or at least sufficiently consistent with, the funding-side time-dependent key. That latter category is added to encompass efforts that vendors and others might use to circumvent the intent of the claims. For example, if the user-side time-dependent key is LJW34TX, a vendor might send that over to a bank clearing house as LJW34TX2. That would not be an exact match with the funding-side time-dependent key is LJW34TX, but there could be an understanding between the two entities that extra characters are to be ignored. For purposes of this patent application, the user-side time-dependent key of LJW34TX2 would be considered sufficiently consistent with the funding-side time-dependent key of LJW34T. What is or is not sufficiently consistent can be determined by or on behalf of the vendor, or by or on behalf of funding entity, preferably whichever entity is willing to take the risk of authorizing based on non-identical codes.

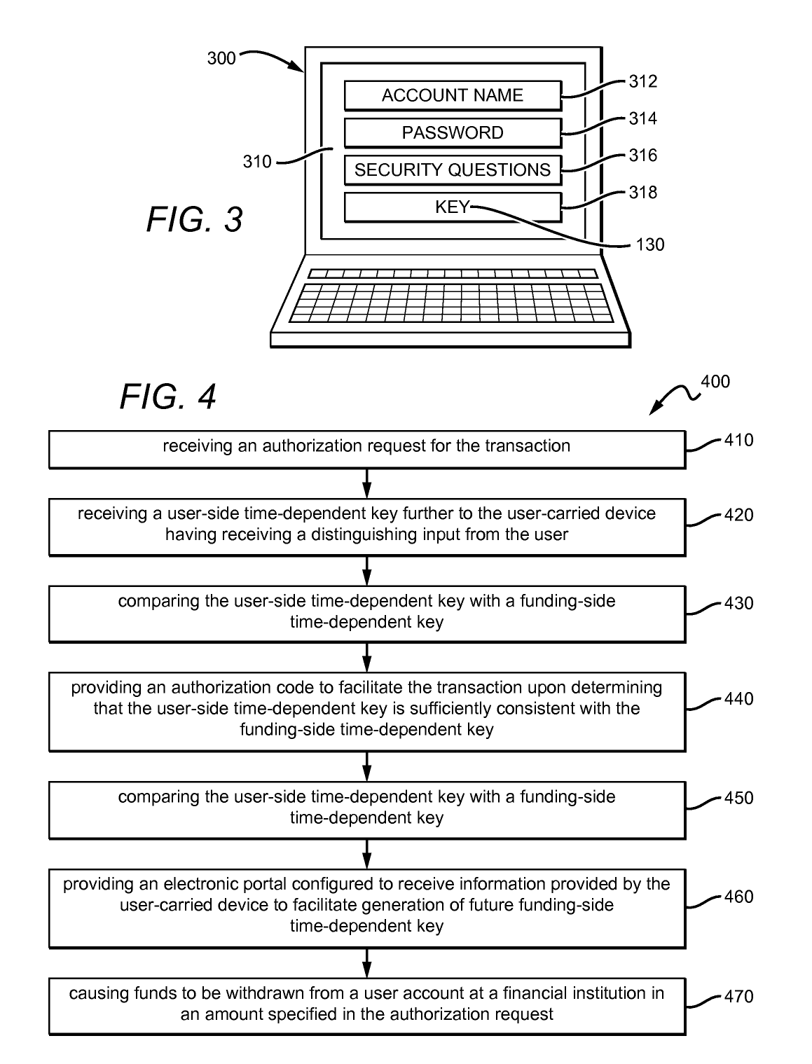

In FIG. 3 the portal is a website 310 rendered by a computer 300, to which the user would gain access by entering an account name and password into the respective fields 312, 314. As part of a set-up process, the user could optionally answer one or more security questions, fields 316, and then enter into another field 318 whatever is the then-current user-side time-dependent key 130 displayed by the cell phone or other user-carried device 120. From that information the portal would effectively run the algorithm in reverse to determine the MAC address or other seed used by the user-carried device 120. And then, until the user changes to a different user-carried device 120, or otherwise changes the seed on the existing device, the user-side time-dependent key should match the funding side funding-side time-dependent key.

Alternatively, the portal could provide a seed to the user-carried device 120, either directly, or indirectly through the user. Either way, the algorithm can be very simple to very complex. For example, algorithms might include some sort of geographic input, so that for example a cell phone taken out of the country or out of a particular geographic region would return a user-side time-dependent key that is inconsistent with the funding side funding-side time-dependent key. Of course, in that instance the user would need to keep the funding-side computer updated on the geographical region in which the phone is supposed to be located. Regardless, it is certainly contemplated that different companies would use different, proprietary algorithms.

There could also be some sort of hand-shaking between the user-carried device 120 and a server operated by or on behalf of the funding side of the transaction. But embodiments along those lines are generally less preferred because they might be perceived by users as being overly inconvenient. For example, there are some advantages to being able to obtain a user-side time-dependent key on an airplane where there is no connectivity between the user-side device and the funding-side key service.

As used herein the term “time dependent” with respect to a key includes both situations where the date/time is expressly used as a variable by an algorithm (possibly along with a different seed) to produce the key, as well as situations where the algorithm is merely time varying. In that latter category, the algorithm produces keys that vary over time, but date/time is not expressly used in the algorithm. For example, a random number generator that starts at a given point in time will produce time varying keys, although the date/time is not expressly used as a variable by the algorithm.

As used herein, the term “commercial transaction” includes business or consumer purchases of goods or services in person, or using an electronic portal such as a website on the Internet. In the former case, it is contemplated that a sales clerk might ring up the transaction on a cash register, and then “run the card” through a card reader. A display on the reader might then ask for a confirmation code, which would be the user-side time-dependent key 130.

FIG. 4 depicts steps of a class of preferred methods 400, in which step 410 is receiving an authorization request for the transaction; step 420 is receiving a user-side time-dependent key further to the user-carried device having receiving a distinguishing input from the user; step 430 is comparing the user-side time-dependent key with a funding-side time-dependent key; and step 440 is providing an authorization code to facilitate the transaction upon determining that the user-side time-dependent key is sufficiently consistent with the funding-side time-dependent key. Step 450 is providing an electronic portal configured to receive information provided by the user-carried device to facilitate generation of future funding-side time-dependent keys. Step 460 is causing funds to be withdrawn from a user account at a financial institution in an amount specified in the authorization request.

Thus, in general, it is contemplated that a user-side electronic device provides a user-side time-dependent key that is accessed through use of an entry key and/or a separate seed. The device might or not be a cell phone, and might or might not have any sort of telephone capability. The device might, for example, be a game player, or a dedicated time-dependent key-producing device.

It should be noted that unless inconsistent with the description, computing devices are generally contemplated herein to include servers, interfaces, systems, databases, agents, peers, engines, controllers, or other types of computing devices operating individually or collectively. One should also appreciate the computing devices comprise a processor configured to execute software instructions stored on a tangible, non-transitory computer readable storage medium (e.g., hard drive, solid state drive, RAM, flash, ROM, etc.). Software instructions preferably configure a computing device to provide the roles, responsibilities, or other functionality as discussed below with respect to the disclosed apparatus. In especially preferred embodiments, the servers, systems, databases, or interfaces preferably exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of utilizing a user-carried device to facilitate a transaction for the user, comprising:
receiving an authorization request for the transaction;
receiving a user-side time-dependent key produced further to the user-carried device having received a distinguishing input from the user; and
providing an authorization code to facilitate the transaction following comparison of the user-side time-dependent key with a funding-side time-dependent key.

2. The method of claim 1 wherein the transaction comprises a purchase by the user.

3. The method of claim 1 wherein the authorization request includes the time-dependent key.

4. The method of claim 1 wherein the user-side time-dependent key is generated by the user-carried device.

5. The method of claim 1 wherein the user-side time-dependent key is generated using a unique device identifier of the user-carried device.

6. The method of claim 1 wherein the user-side time-dependent key is valid for a time period no greater than five minutes.

7. The method of claim 1 wherein the user-side time-dependent key is provided orally to an intermediary.

8. The method of claim 1 wherein the user-side time-dependent key is transmitted electronically to an intermediary by the user-carried device.

9. The method of claim 1 further comprising providing an electronic portal configured to receive information utilized by the user-carried device to facilitate generation of future time-dependent keys.

10. The method of claim 1 further comprising facilitating provision of software that can be loaded onto the user-carried device to generate future user-side time-dependent keys.

11. The method of claim 1 wherein the user-carried device has a telephony capability.

12. The method of claim 1 wherein the user-carried device is a cell phone that generates the user-side time-dependent key further to the user entering an entry key to the cell phone.

13. The method of claim 12 wherein the user-carried device is a cell phone that generates the user-side time-dependent key further to the user entering a seed to the cell phone, wherein the seed is different from the an entry key.

14. The method of claim 1 wherein the user-carried device is a cell phone that generates the user-side time-dependent key further to the user entering a seed to the cell phone, and the seed varies by at least one of day, date, time of day, and amount of transaction.

15. The method of claim 1 wherein the user-carried device is a cell phone that generates the user-side time-dependent key further to the user entering a seed to the cell phone, and the seed varies by at least one of identity of user, day, date, time of day, and amount of transaction.

16. A method of authorizing a credit card transaction, comprising:
facilitating provision of software that operates on a cell phone, wherein the software is capable of providing user-side time-dependent keys;
receiving a current one of the user-side time-dependent keys as part of an authorization process of a commercial transaction;
transferring funds to further the transaction following comparison of the current user-side time-dependent key with a current funding-side time-dependent key.

17. The method of claim 16, wherein the software provides the time-dependent key further to receiving a seed that varies by at least one of identity of user, day, date, time of day, and amount of transaction.

18. The method of claim 16, wherein the step of receiving a current one of the user-side time-dependent key comprises receiving a concatenation of a confidential passcode and user-side time-dependent keys the current user-side time-dependent key.

19. An app operable on a cell phone, wherein the app is capable of providing time-dependent keys further to a user providing a distinguishing input.

20. The app of claim 19, wherein the seed varies by at least one of identity of user, day, date, time of day, and amount of transaction.
